(19) United States
(12) Patent Application Publication
(10) Pub. No.: US 2010/0011932 A1
(43) Pub. Date: Jan. 21, 2010

(54) CUTTING PUNCH HOLDER

(75) Inventor: Timothy SIMON, Wooster, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/481,911

(22) Filed: Jun. 10, 2009

Related U.S. Application Data
(60) Provisional application No. 61/135,509, filed on Jul. 21, 2008.

(51) Int. Cl. B26D 7/26

(52) U.S. Cl. 83/698.31; 83/698.91; 83/699.31

(57) ABSTRACT

A cutting punch sleeve including a bore with a first diameter at a first end and a second diameter, larger than the first diameter, at a second end, opposite the first end, and an outer surface with an indent. The bore is for receiving a cutting punch, the sleeve is locatable in a ball-lock assembly, and the indent is for engaging a ball in a ball-lock assembly to fix the sleeve in the ball-lock assembly. In one embodiment, at least a portion of the outer surface is matingly engageable with a surface for a recess in the ball-lock assembly. In another embodiment, a portion of the bore proximate the second end is shaped to matingly engage a head for the cutting punch.

### CROSS-REFERENCE TO RELATED APPLICATIONS

This application claims the benefit under 35 U.S.C. §119(e) of U.S. Provisional Application No. 61/135,509, filed Jul. 21, 2008, which application is incorporated herein by reference in its entirety.

### FIELD OF THE INVENTION

The invention relates to means for holding a punch in a die for a metal working process.

### BACKGROUND OF THE INVENTION

In the field of metal working, it is known to use stamping dies and presses to form shapes out of raw material, for example, to stamp holes and shapes into a metal work piece. To punch holes through the material, it is common practice to use piercing punches in the dies to accurately place and size cutouts. Piercing punches must be periodically removed for sharpening, to enable use of a different punch, or to replace the punch due to wear or breakage. Unfortunately, removal can be a time consuming and costly process.

U.S. Pat. No. 5,410,932 teaches a ball-lock assembly for retaining an item inserted in the assembly. Unfortunately, the assembly would be built into a die plate, which is a costly process and which limits use of the assembly. Also, if the item is a punch, the punch must be formed with a recess to interface with the ball in the assembly, increasing the cost of the punch. U.S. Pat. No. 7,051,635 discloses a ball-lock assembly that can be inserted into a die. Unfortunately, the die must be disassembled to remove a punch or a retainer for the assembly and, use of the assembly still requires specially shaping for the punch. U.S. Published Patent Applications Nos. 2007/0101849 and 2007/0209494 teach a modular ball-lock assembly. Unfortunately, the die must be disassembled to remove the assembly and, use of the assembly still requires specially shaping for the punch.

It is known to use punches with specially shaped heads, for example, heads having a greater diameter that the main body of the punch, to off set stripping forces on the punch. For example, when a punch is retracted after a piercing operation, frictional forces between the punch and the work piece resist movement of the punch through the work piece and exert a force pulling the punch away from a die plate or other device holding the punch. It is known to use trumpet headed punches, for example, as produced by Steinel Normalien (Germany), in metal working operations. Unfortunately, the use of trumpet headed punches requires costly special machining of the holding assembly. Also, it is difficult to remove the punches once installed in the holding assembly.

Thus, there is a long-felt need for a means of facilitating installation and removal of a punch in a holding assembly, in particular, for a trumpet headed punch.

### BRIEF SUMMARY OF THE INVENTION

The present invention broadly comprises a cutting punch sleeve, including a bore with a first diameter at a first end and a second diameter, larger than the first diameter, at a second end, opposite the first end and an outer surface with an indent. The bore is for receiving a cutting punch, the sleeve is locatable in a ball-lock assembly, and the indent is for engaging a ball in a ball-lock assembly to fix the sleeve in the ball-lock assembly. In one embodiment, at least a portion of the outer surface is matingly engageable with a surface for a recess in the ball-lock assembly. In another embodiment, a portion of the bore proximate the second end is shaped to matingly engage a head for the cutting punch.

The present invention also broadly comprises a cutting punch holder, including: a ball-lock assembly, with a first recess, a first bore in communication with the first recess, and a ball and spring at least partially disposed within the first bore; and a sleeve disposed in the first recess and including a second bore and an outer surface with an indent engaged with the ball for fixing the sleeve in the first opening. The second bore includes a first diameter at a first end and a second diameter, larger than the first diameter, at a second end, opposite the first end and the second bore is for receiving a cutting punch. In one embodiment, the first recess includes a first surface and the sleeve includes an outer circumferential surface and at least portions of the first surface and the outer circumferential surface are matingly engaged. In another embodiment, a portion of the second bore proximate the second end is shaped to matingly engage a head for the cutting punch.

In one embodiment, the first recess includes an end in contact with an end for the sleeve. In another embodiment, a portion of the end for the first recess overlaps the second bore. In a further embodiment, the ball-lock assembly includes a third bore, in communication with the first bore, for receiving a member to urge the ball against the spring to release the sleeve from the ball-lock assembly. In yet another embodiment, the ball-lock assembly includes a second recess for receiving a pin to locate the holder on a die plate. In a still further embodiment, the second recess is a third bore coaxially aligned with the second bore.

It is a general object of the present invention to provide a means of quickly and cost-effectively inserting, retaining, and removing specially shaped punches.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 a cross-sectional view of the of a present invention cutting punch sleeve; and,

FIG. 2 is a cross-sectional view of the of a present invention cutting punch holder with a punch.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

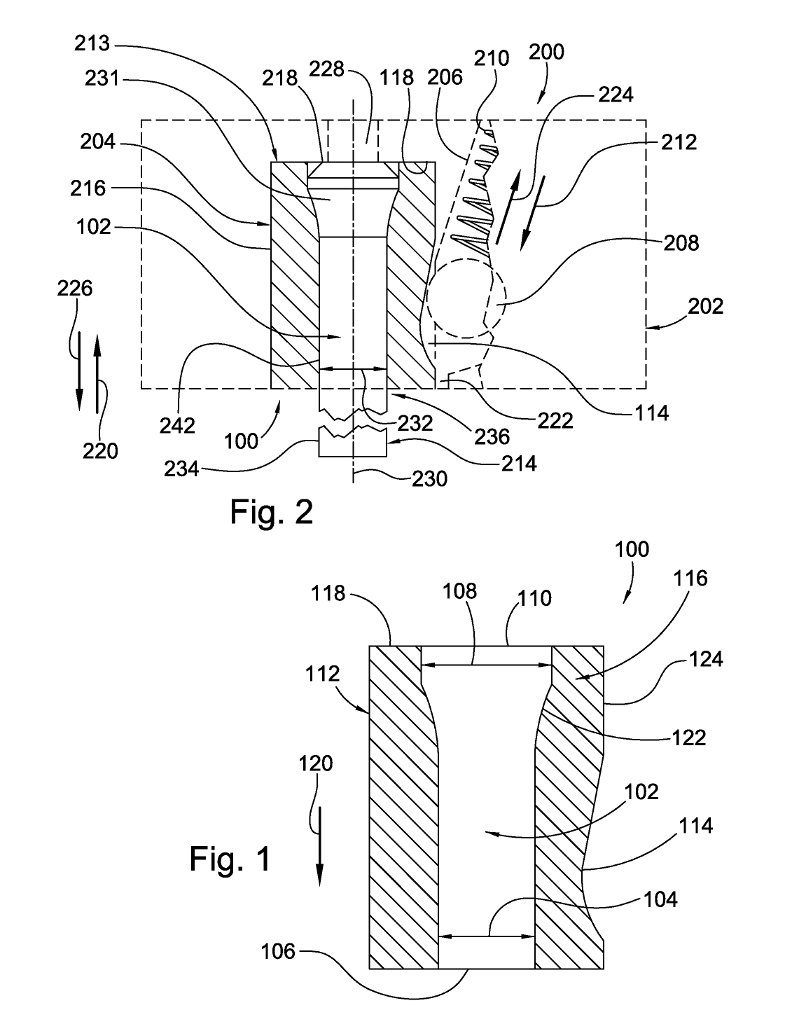

FIG. 1 is a cross-sectional view of present invention cutting punch sleeve 100. Sleeve 100 includes bore 102 with a diameter 104 at end 106 and diameter 108, larger than diameter 104, at end 110, opposite end 106. As described infra, bore 102 is for receiving a cutting punch (not shown). That is, a cutting punch can be inserted in the bore. The sleeve also includes outer surface 112 with indent 114. As, described infra, the sleeve is locatable in a ball-lock assembly (not shown) and the indent is for engaging a ball in a ball-lock assembly to fix the sleeve in the ball-lock assembly. In one embodiment, at least a portion of outer surface 112 is matingly engageable with a surface for a recess in the ball-lock assembly. For example, portions the sleeve are snuggly placeable in the ball-lock assembly. In another embodiment, portion 116 of the bore proximate end 110 is shaped to matingly engage a head for the cutting punch.

FIG. 2 is a cross-sectional view of the of present invention cutting punch holder 200 with a punch. The following should be viewed in light of FIGS. 1 and 2. Cutting punch holder 200 includes ball-lock assembly 202 and sleeve 100. The assembly includes recess 204 and bore 206 in communication with the recess. That is, bore 206 opens into the recess. The assembly also includes ball 208 and spring 210. The ball and spring are at least partially disposed within bore 206. For example, a portion of the ball is in the bore and a portion of the ball is in the recess.

Sleeve 100 is removably disposed, that is, located, in the recess. For example, the sleeve can be inserted in or removed from the recess as further described infra. Indent 114 is engaged with the ball for fixing the sleeve in the recess. For example, the end (not shown) of the spring opposite the ball is fixed and the spring reacts to urge the ball in direction 212, against the sleeve, and indent 114 in particular. Cutting punch 214 is removably disposed, that is, placed, in bore 102. For example, the punch can be inserted in or removed from the bore as further described infra. Punch 214 is used as an example in the discussion infra; however, it should be understood that a present invention sleeve or holder is not limited to use with any particular punch, for example, punch 214.

Recess 204 includes inner surface 216 and at least portions of surfaces 216 and 112 are matingly engaged. In one embodiment, end 213 of the recess is in contact with end 118 for the sleeve. In another embodiment, portion 218 of end 212 overlaps bore 102. Thus, portion 218 fixes punch 214 in direction 220. In another embodiment, the ball-lock assembly includes bore 222, in communication with bore 206. Bore 222 is for receiving a member, for example, a pin or dowel (not shown), to urge the ball against the spring to release the sleeve from the ball-lock assembly. For example, the pin can be inserted through bore 222 to contact the ball and to push the ball, causing the ball to move in direction 224 away from the sleeve until the ball is radially outside of surface 216, enabling displacement of the sleeve in direction 226. In a further embodiment, the ball-lock assembly includes a recess 228 for receiving a pin (not shown) to locate the holder on a die plate. In yet another embodiment, recess 228 is a bore in communication with recess 204. In yet a further embodiment, bore 228 and recess 204 are IS coaxially aligned, for example, with respect to axis 230.

The following provides further detail regarding sleeve 100 and holder 200. In one embodiment, the ball-lock assembly is assembled into a stamping die plate as a sub assembly. In another embodiment, the ball-lock assembly is machined into the plate. Recess, or assembly hole, 228 is used to locate the assembly into the die plate. For example, a dowel pin can be inserted in the assembly hole and then placed in a hole in the die plate to fix the assembly at a predetermined location on the plate. In a further embodiment the assembly hole is coaxial and concentric with bore 102, which has a larger diameter, for example, diameters 104 and 110. The spring moves to locate the ball into a force interaction with the sleeve. This interaction holds the sleeve in the assembly, for example, recess 204, so that the sleeve does not fall out under use. The sleeve includes contoured cavity, cut surface, or indent 114 on the external radius of the sleeve, for example, on surface 112.

Hole 102, in particular, end 110, is machined to have a profile to match a contoured shape of a punch to be inserted in the hold, in particular, a head for the punch, for example, head 231 of punch 214, which has a greater radial extent than diameter 232 of the punch. This profile, along with the ball-lock assembly, is used to locate and hold the punch in a single, fixed position, for example, as shown in FIG. 2. Contoured cavity 114 receives the ball to create a friction force holding engagement. This engagement enables the sleeve and punch to be pushed up into the assembly. However, the engagement resists a force applied in direction 226 on the punch and/or sleeve, locking the sleeve into the assembly. To remove the sleeve, the ball can be pushed by a tool (not shown) inserted in bore 222 to release the force from the ball acting on the sleeve and to enable the sleeve or sleeve and punch to be removed, for example, for replacement, from the assembly. The internal profile at end 110 of bore 102 can be shaped to fit, or accept a multitude of punch heads including, but not limited to, a trumpet head, shoulder head or any other contoured shape that allows for the punch to be held in place while under load form use in the die.

Referring to FIG. 1, to use sleeve 100, one end of a punch, for example, end 234 of punch 214 is inserted in end 110 of bore 102 and displaced in direction 120 until a radial protrusion for the punch, for example, the head of the punch, such as head 231, contacts shoulder/protrusion 122, formed by intersection of the larger diameter proximate end 110 with diameter 106, which prevents the punch from displacing any further in direction 120. In general, diameter 106 is slightly larger than diameter 232 of the punch to enable a slidable, but secure fit between the punch and the sleeve.

Referring to FIG. 2, once the punch is engaged as described supra, end 118 is inserted in mouth 236 for recess 204 and displaced in direction 220 until end 118 contacts end 213 of the recess. Portion 124 of surface 112 above the indent forces the ball back into bore 206. Indent 114 is shaped such that the indent acts as a ramp enabling the sleeve to move in direction 220, for example, the shape enables the ball to displace in direction 212. Once the sleeve is positioned as shown in FIG. 2, the shape of the indent and the force applied by the ball resist movement of the sleeve in direction 226. Thus, the sleeve is substantially locked in the assembly. Advantageously, the contact of the punch head with the sleeve and the locking of the sleeve by assembly 202 provides a very large resistance to any stripping forces associated with the use of a punch in holder 200. As well, sleeve 100 and holder 200 advantageously enable use of a punch with a standard shaft having a uniform diameter below the head, for example, shaft 242, eliminating the need for costly specially machining of the shaft to accommodate use in a die as described supra and greatly increasing the number and type of punches usable with sleeve 100 and holder 200. Further, a punch can advantageously be removed from holder 200 without any disassembly of the die plate with which the holder is being used, through use of bore 222 as described supra, thus greatly reducing time and cost associated with the removal and replacement of punches.

In one embodiment, all or some of the bores, openings, and recess described supra are circular in cross-section. However, it should be understood that any cross-sectional shape known in the art can be used for the bores, openings, and recess described supra.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A cutting punch sleeve, comprising:
a through bore with a first diameter at a first end and a second diameter, larger than the first diameter, at a second end, opposite the first end, wherein the bore is arranged to receive a cutting punch; and,
an outer surface with an indent, wherein the sleeve is locatable in a ball-lock assembly and the indent is arranged to engage a ball in the ball-lock assembly to fix the sleeve in the ball-lock assembly.

2. The cutting punch sleeve of claim 1 wherein at least a portion of the outer surface is matingly engageable with a surface for a recess in the ball-lock assembly.

3. The cutting punch sleeve of claim 1 wherein a portion of the bore proximate the second end is shaped to matingly engage a head for the cutting punch.

4. A cutting punch holder, comprising:
a ball-lock assembly, including a first recess, a first bore in communication with the first recess, and a ball and spring at least partially disposed within the first bore; and,
a sleeve disposed in the first recess and including a second bore and an outer surface with an indent engaged with the ball for fixing the sleeve in the first recess, wherein the second bore includes a first diameter at a first end and a second diameter, larger than the first diameter, at a second end, opposite the first end and wherein the second bore is arranged to receive a cutting punch.

5. The cutting punch holder of claim 4 wherein the first recess includes a first surface and the sleeve includes an outer circumferential surface and wherein at least portions of the first surface and the outer circumferential surface are matingly engaged.

6. The cutting punch holder of claim 4 wherein a portion of the second bore proximate the second end is shaped to matingly engage a head for the cutting punch.

7. The cutting punch holder of claim 4 wherein the first recess includes an end and wherein the sleeve includes an end in contact with the end for the recess.

8. The cutting punch holder of claim 7 wherein a portion of the end for the first recess overlaps the second bore.

9. The cutting punch holder of claim 4 wherein the ball-lock assembly includes a third bore, in communication with the first bore, for receiving a member to urge the ball against the spring to release the sleeve from the ball-lock assembly.

10. The cutting punch holder of claim 4 wherein the ball-lock assembly includes a second recess for receiving a pin to locate the holder on a die plate.

11. The cutting punch holder of claim 10 wherein the second recess is a third bore coaxially aligned with the second bore.
